(19) United States
(12) Patent Application Publication
(10) Pub. No.: US 2009/0327900 A1
(43) Pub. Date: Dec. 31, 2009

(54) INDICATING RESOURCES TO WHICH THERE ARE ACCESS RIGHTS

(75) Inventors: LINDSEY NOLL, Seattle, WA (US); CHRISTOPHER JOHN GUZAK, Kirkland, WA (US); STEVE F. SEIXEIRO, Snohomish, WA (US); JERRY K. KOH, Bothell, WA (US); GURJOT BRAR, Renton, WA (US); KENNETH M. TUBBS, Issaquah, WA (US); ANSHUL RAWAT, Kirkland, WA (US); RELJA B. IVANOVIC, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/147,010

(22) Filed: Jun. 26, 2008

(51) Int. Cl. G06F 3/00

(52) U.S. Cl. 715/733

(57) ABSTRACT

Methods and computer storage media for displaying shared resources of a sharing device to which a computing device of a network has access are provided. Shared resources of a sharing device are determined. A message is generated that includes information regarding the shared resource. The message is communicated to a computing device that interprets the message to identify those resources that are shared with the computing device. Upon determining those resources that the computing device has access rights, the computing device provides an indication for a user that facilitates the utilization of those shared resource to which it has access rights. In some embodiments, the message is securely communicated.

### BACKGROUND

Generally, sharing of resources among networked computing devices is inefficient and difficult because the resources must first be located on other computing devices. Once the resource have been located, then an attempt to access those resources must be performed. Only then is it discovered that those resources have not been shared or do not include proper access rights to allow utilization of the resources. Typically, from a user's perspective, a user of a computing device that wishes to access a resource of a different computing device must search for that resource over a network. The user then must attempt to access the resource once it has been located. Once the user has attempted to access the resource, at that time, the user is informed if the user has the proper access rights to the resource

### SUMMARY

Embodiments of the present invention relate to methods and computer storage media for displaying shared resources of a sharing device to which a computing device of a network has access. Resources of a sharing device are identified as having access rights that allow the computing device to have access. The network communicates a message identifying those resources that are shared with one or more computing devices. The receiving computing device interprets the message and identifies those resources to which it has access. The receiving computing device provides an indication for the resource to which the computing device has access, in order to facilitate use of that resource.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram that illustrates an exemplary networked computing system configured for use in implementing embodiments of the present invention;

FIG. 3 is a process diagram that illustrates an exemplary process flow for displaying shared resources of a sharing device on a computing device, in accordance with an embodiment of the present invention;

FIG. 4 is a flow diagram of an exemplary method for displaying shared resources to which one or more computing devices of a network have access, in accordance with an embodiment of the present invention;

FIG. 5 is another flow diagram of an exemplary method for displaying shared resources to which one or more computing devices of a network have access, in accordance with an embodiment of the present invention;

FIG. 6 is another flow diagram of an exemplary method for displaying shared resources to which one or more computing devices of a network have access, in accordance with an embodiment of the present invention; and

FIG. 7 is an exemplary illustration of a suitable user interface for displaying an indication of those resources to which the displaying computing device has access rights.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among the various steps herein disclosed unless and except when the order of individual steps is explicitly described.

Embodiments of the present invention relate to methods and computer storage media for displaying shared resources of a sharing device to which a computing device of a network has access. Resources of a sharing device are identified as having access rights that allow the computing device to have access. The network communicates a message identifying those resources that are shared with one or more computing devices. The receiving computing device interprets the message and identifies those resources to which it has access. The receiving computing device provides an indication for the resource to which the computing device has access, in order to facilitate use of that resource.

Accordingly, in one aspect, the present invention provides computer storage media having computer-executable instructions embodied thereon that, when executed perform a method for displaying shared resources to which one or more computing devices of a network have access. The method includes identifying the shared resources of a sharing device that are shared with the one or more computing devices when access rights have been granted to the one or more computing devices. Additionally, the method comprises creating a message indicating, at least, which of the one or more computing devices have access rights to the resources. Further, the method includes communicating the message to the one or more computing devices, wherein at least one member of the one or more computing devices can interpret the message to identify the resources of the sharing device that are available to the member, so the member can display only those resources included in the message to which the member has access rights.

In another aspect, the present invention provides a method for displaying shared resources of a sharing device to which a computing device of a network has access. The method includes receiving a message from the sharing device including a listing of the shared resources of the sharing device, and identifying the computing device as having access rights to at least one of the shared resources. Additionally, the method includes interpreting the message to determine which of the shared resources the computing device has access rights. Further, the method includes displaying on the computing device an indication of the shared resources to which the computing device has access rights, and facilitating utilization of the shared resources to which the computing device has access rights by way of the indication.

A third aspect of the present invention provides computer-storage media having computer-executable instructions embodied thereon for performing a method of displaying shared resources to which a member of one or more computing devices of a network has access. The method includes receiving a selection of the sharing-device resources that are shared with a user of the member. The access rights to the resources are stored in association with the user to which they are shared in the form of Access Control Entries (ACE). Additionally, the method includes formatting the ACE to be communicated by way of a Window Service Discovery (WSD) message to the one or more computing devices, such that the WSD message will be securely communicated utilizing public key encryption. Further, the method includes securely communicating the WSD message to the one or more computing devices, wherein the member interprets the WSD message to determine if at least one of the ACE is applicable to the member, and upon determining at least one of the ACE is applicable, the member displays an icon linking the resource sharing device associated with the member. Upon selection of the resources by way of the icon displayed on the member, the method includes receiving a request to utilize the resources by the member, such that the WSD message provides information on the location of the resources to facilitate utilization of the resources by the member.

Having briefly described an overview of the embodiments of the present invention, and exemplary operating environment suitable for implementing embodiments hereof is described below.

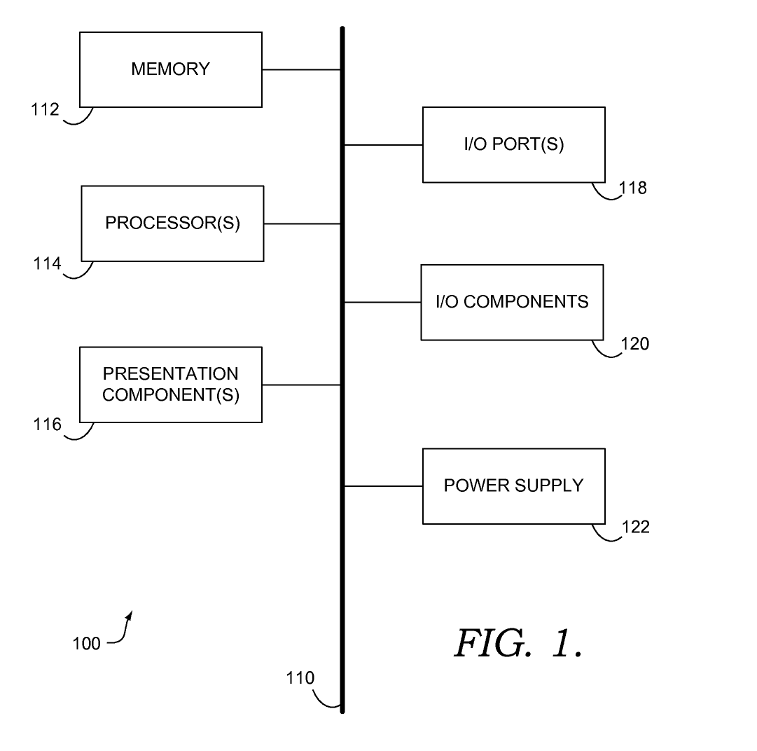

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

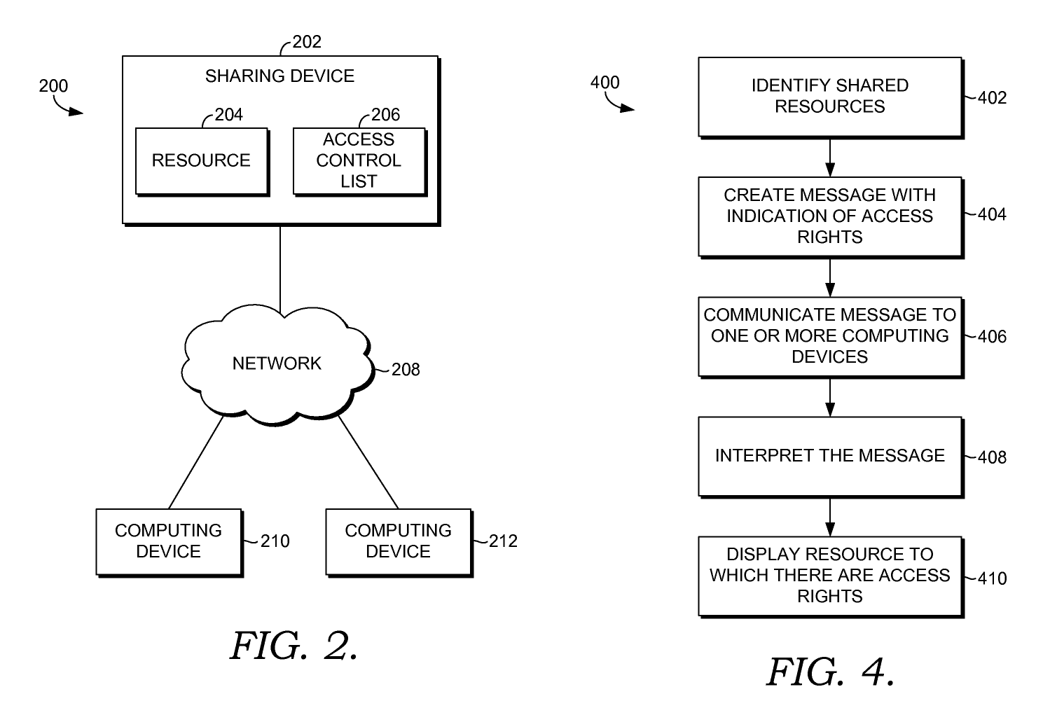

With reference to FIG. 2, a block diagram is illustrated that shows an exemplary networked computing system 200 configured for use in implementing embodiments of the present invention. It will be understood and appreciated by those skilled in the art that exemplary networked computing system 200 shown in FIG. 2 is merely an example of one suitable configuration and is not intended to suggest any limitations as to the scope or functionality of the present invention, nor should networked computing system 200 be interpreted as having any dependency or requirement related to any single module, component, or device illustrated or described herein.

Networked computing system 200 includes a sharing device 202, which has a resource 204 that can be shared with one or more additional computing devices, such as computing device 210, and computing device 212. Computing devices 210 and 212, in an exemplary embodiment, are comparable to computing device 100, discussed hereinabove with reference to FIG. 1. Sharing device 202 also has an access control list 206. Sharing device 202 is coupled to a network 208. The network 208 may include, without limitation, one or more local networks, (LANs) and/or wide area networks (WANs). Such networking environments are commonplace in offices, enterprise-wide computer networks, intranets and the internet. Accordingly, the network 208 is not further described herein.

Sharing device 202, in an exemplary embodiment is a computing device, such as computing device 100 discussed hereinabove with reference to FIG. 1. In an exemplary embodiment of the present invention, sharing device 202 is a personal computing device that utilizes a graphical user interface based operating system, such as Microsoft® Windows®, available from Microsoft Corporation of Redmond Wash. Yet, in alternative exemplary embodiments, sharing device 202 is any computing device having a processor and memory wherein the computing device is accessible by other comparable or different computing devices to access at least one resource on the computing device.

Resource 204 is a resource of sharing device 202 that has been identified as being accessible, useable, or functional for at least one other computing device that communicates through network 208. For example, resource 204 may include, in alternative embodiments, the various devices discussed with reference to FIG. 1, such as memory 112, processor 114, presentation module 116, input/output (I/O) ports 118, and/or I/O modules 120. In order to facilitate a better understanding, these modules/devices include, but are not limited to, disks, drives, monitors, projectors, scanners, printers, communication modems, and removable storage. In an exemplary embodiment, resource 204 shared by device 202 is one or more files that are located on the memory of the sharing device. For example, the user of sharing device 202 can identify a collection of documents stored on sharing device 202 as being sharable with the user of computing device 210. As such, the user of computing device 210 can access and utilize the documents of sharing device 202 by way of computing device 210. In essence, the designated resources of the sharing device, while they are directly associated with the sharing device, are available to other computing devices and their users as a result of being designated as shareable.

Access control list (ACL) 206 represents a listing of those resources 204 of sharing device 202 that are shared, to which identities they are shared, and at what level of permission the resources are shared to each of the identities. Stated differently, an ACL is a list of permissions attached to an object, such as a resource. The list specifies who or what is allowed to access the object and what operations are allowed to be performed on the object. In a typical ACL, each entry in the list specifies a subject and an operation. For example, the entry (Alice, delete) on the ACL for file XYZ gives Alice permission to delete file XYZ. Each of the entries in an ACL is an Access Control Entry (ACE). The privileges or permissions associated with each ACE determine specific access rights, such as whether a user can read from, write to, or execute an object. In some implementations, an ACE can control whether or not a user, or group of users, may alter the ACL on an object.

In an exemplary embodiment of the present invention, the current user of sharing device 202 identifies that a specific file directory, such as a directory containing all of the music files of sharing device 202 should be accessible to read only by a specific user, Alice. The ACL is updated to include an ACE that identifies Alice, by way of a unique identity associated with Alice, and indicating that she has read-only rights/privileges to the music directory of the sharing device 202.

A resource is identified as being a shared resource in a variety of ways. For example, a user of sharing device 202 having proper rights/permissions can select one or more resources of sharing device 202 to be accessible by one or more users/computing devices. In an exemplary embodiment, a first user of sharing device 202 selects, chooses, or otherwise indicates that a specific resource is accessible by a specified user, group of users, computing device, or group of computing devices at a defined permission level, such as read only, write, or execute. If the first user has appropriate rights/permission that allow the first user to share the identified resources, then an ACL is updated with a modified or new ACE that indicates the resource is accessible to the indicated identities. The identities include the selected user, group of users, computing device, and group of computing devices. It is understood and appreciated by those skilled in the art that the resources that are shared may be identified by methods other than those described above. For example, instead of an ACL that indicates the resources that are shared, a registry or wizard may be utilized to identify those resources that are shareable with one or more users.

When resources are identified as being shared with one or more computing devices, the resources are shared as a result of the association between a particular user and the computing device because the resources are shared with a particular user of the computing device as opposed to the resource being shared with the computing device specifically. For example, a music directory of a sharing device that is indicated as being shared with a particular user, Alice, is actually shared with a particular computing device when Alice is the user of that particular computing device. So, when it is stated herein that access rights are identified to share a resource with a computing device, this incorporates the scenario where the access rights are associated with a particular user, and as a result, the computing device of the particular user has access rights while that particular user is associated with the computing device.

Therefore, in an exemplary embodiment, when a resource 204 of sharing device 202 is identified as being shared with a user of computing device 210, the user of computing device 210 can access the resource 204 through computing device 210 by way of network 208. Further, when resource 204 is identified as being shared with a user associated with computing device 210 and a user associated with computing device 212, both computing devices 210 and 212 can be utilized to access resource 204 by each user through their respective computing device.

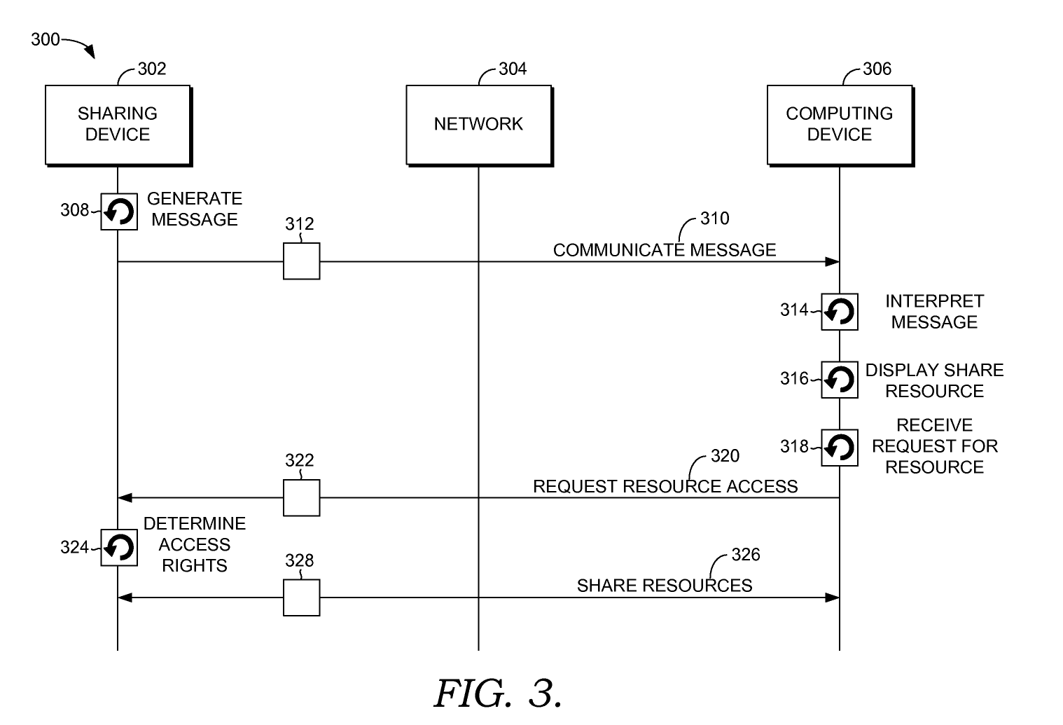

With reference to FIG. 3, a process diagram is shown that illustrates an exemplary process flow 300 for displaying shared resources of a sharing device on a computing device, in accordance with an embodiment of the present invention. It will be understood and appreciated with those of ordinary skill in the art that the process diagram is merely an exemplary diagram to facilitate understanding of an exemplary embodiment of the present invention and is not intended to suggest any limitation as to the scope of use or functionality of the present invention.

Process flow 300 provides a graphical representation of the process flow of an exemplary process for displaying shared resources of a shared device. Process flow 300 includes a sharing device 302, a network 304, and a computing device 306. In an exemplary embodiment, sharing device 302 is comparable with sharing device 202, network 304 is comparable with network 208, and computing device 306 is comparable with computing device 210, all discussed above with reference to FIG. 2.

Process flow 300 includes sharing device 302 generating a message 308. Generating message 308 is done in response to identifying the resources of sharing device 302 that are shared with one or more computing devices, such as computing device 306. The message generated is a message that includes information of the sharing device resources that are shared. For example, the ACL of sharing device 302 is evaluated to identify the resources of sharing device 302 that are shared with one or more computing devices. Once the resource to be shared has been identified, a message is generated that includes information of the ACL, but in a format that is able to be interpreted by the one or more computing devices to which the resources are shared. In an exemplary embodiment, the message is generated as a Windows Services Discovery (WSD) message. The WSD message serves as a vehicle for communicating the information concerning the shared resources of the sharing device.

Information that can be contained in the generated message 308 includes information derived from the ACL, such as the resource to be shared, to whom it is shared, and at what level of permission it is shared with each of the entities to which it is shared. Additionally, the message can include location information that is useable to locate the shared resource. For example, the location information may include a network address, a port address, a Uniform Resource Locator (URL), a drive, a disk, or a directory. Further, the location information may include routing information to provide a communications path for communicating with the shared resource. Additionally, the information included in the message may include icon information for the shared resource, language information of the sharing device or the resource that is shared, an identification of the owner that owns the resource to be shared, the name associated with the shared resource, and the item type of the shared resource. For example, the information included in a generated message for an executable file that is a shared resource includes an identifier that the resource is an executable file, information relating to the graphical icon that should be displayed in conjunction with the executable file, and the name of the executable file that should also be displayed. The information of message 308 is not limited to the exemplary embodiment discussed above, instead it is contemplated that additional information may be included with message 308. For example, additional information may be included with message 308 so as to be utilized by additional computing devices.

In an alternative exemplary embodiment, the location information is condensed to facilitate the generation of an efficient message. For example, if a directory containing digital pictures on the sharing device is identified as being shared, and that directory is commonly found on computing devices that may access the directory, a truncated address or identifier may be included in the message to identify the location of the resource. In an exemplary embodiment, if a “My Pictures” folder is shared from the sharing device to a user of a computing device, the message that is generated may refer to the “My Picture” folder by an alias or identifier that does not explicitly indicate how to locate the shared folder, but, because of the consistency of the “My Picture” folder across multiple computing devices, the ability to locate the “My Pictures” folder is accomplished without the actual location identifier that may be utilized for a less common type of resource. In an alternative exemplary embodiment, an XML description of the resource location is truncated as opposed to the actual location. The truncation of the location description provides a way of minimizing the information utilized to located the resource while still maintaining a dynamic locating system that is not dependent on a particular computing device structure or design.

The generated message 308 is communicated to one or more computing devices. In an exemplary embodiment, the message is “pushed” to the network and, as a result, one or more computing devices. The push of the generated message means that the message is broadcast to the network without a specific request for the message. For example, the sharing device creates the message and communicates the message to the network without specifying to whom the message is intended to be communicated and without a request for the message to be generated or communicated. In other words, a pushed message is an unsolicited message. In the alternative, a “pulled” communication is one where a requesting device has solicited the information from the sharing device. A pulled message requires that the requesting device be aware that a sharing device is available to provide the requested message. Additionally, message 308 is contemplated to include a single message or a series of messages, where the series of message function comparably to message 308. Further, in exemplary embodiments the message is communicated to each user of the one or more computing device, to each member of the one or more computing device, or any combination of users and members.

The generated message 308, in an exemplary embodiment, is pushed to the network each time there is a change in the information that would be included in the generated message. In an alternative embodiment, the message is only generated at predefined times or in response to predefined criteria. Additionally, the generated message 308 in an exemplary embodiment includes information relating to all resources of the sharing device that are shared regardless of the sharing device user that is doing the sharing. In the alternative, the generated message 308 includes only information of those resources of the sharing device that are shared by the current user of the sharing device.

Continuing with reference to FIG. 3, the message 312 is communicated 310 from sharing device 302 through the network 304 to the computing device 306. Message 312, in an exemplary embodiment, is securely communicated. Secure communication can be attained by way of public key encryption, private key encryption, or use of a digital signature. It is understood and appreciated by those having ordinary skill in the art that secure communication may be conducted in a variety of ways and the discussed methods are merely examples, and that a variety of secure communication methods may be utilized to achieve secured communication.

Computing device 306 receives the message 312 and interprets the message 314. The interpretation of the message, in an exemplary embodiment includes parsing the information of the message to identify those resources that are shared with the receiving computing device. For example, if a resource is shared with a user, Alice, and Alice is the user of computing device 306, computing device 306 would parse out those resources indicated in the message that are authorized for Alice to access. Therefore, the parsing portion of interpreting the message identifies those resources that are relevant to the computing device. Upon parsing the message, computing device 306 displays the shared resources 316.

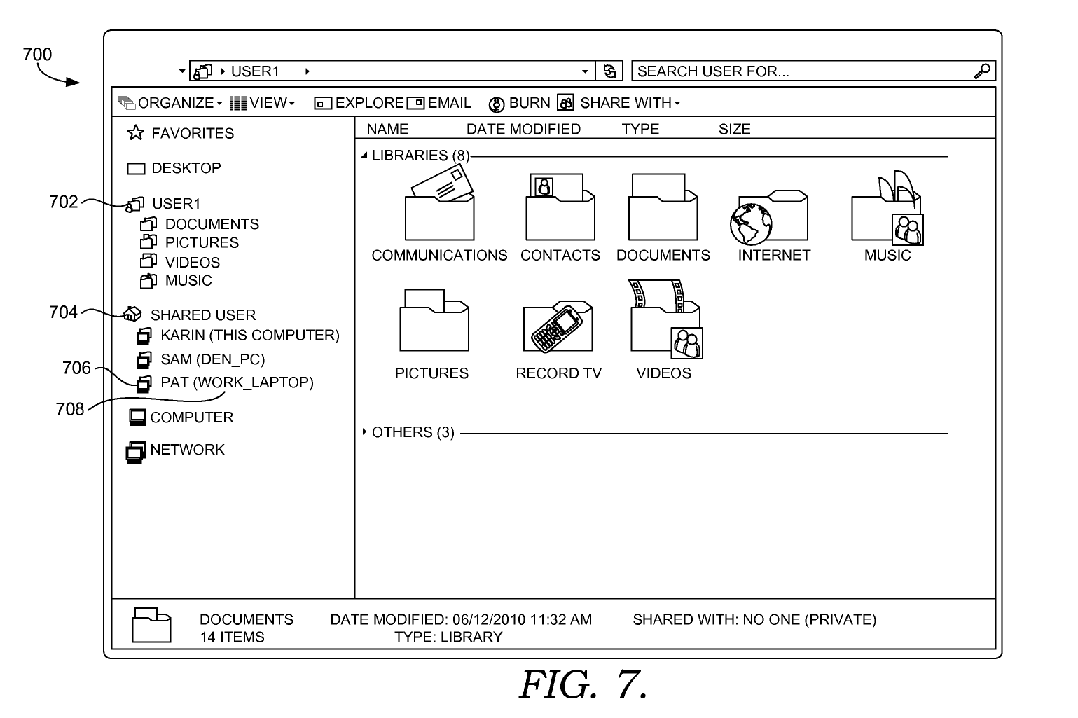

Display of shared resource 316 includes providing an indication on the computing device 306, the indication that the shared resource is available to be accessed. An indication includes a graphical icon that is presented on computing device 306 in a graphical directory of resources available by way the computing device 306. For example, in an exemplary embodiment, after parsing a message, the computing device 306 includes an icon in the file-system explorer window for each resource that is available to the computing device. Further, the icons displayed in the file system explorer window(as discussed and shown below with reference to FIG. 7) include only those resource that are available to the computing device, and not the other resources of the message that are not available to the computing device 306. The graphical icon may be derived from the information of the message if the message includes icon information. Once an indication is provided on the computing device, the user of the computing device can request the resource. It is contemplated that a graphical icon is but one indication. The indication includes visual, tactile, audible, and other sensory stimulants that provide an alert as to the presence of the indication.

In an exemplary embodiment, displaying the shared resource includes installing the shared resource on the computing device to which it is displayed. For example, if the shared resource is a printer that is shared with a computing device, when the shared printer is “displayed” on the computing device, the shared printer is installed on the computing device. The installation of the shared printer provide access to the printer resources by the computing device or a user of the computing device. Displaying is not limited the presentation or installation of a resource, but instead includes accessing, utilizing, authorizing, and loading the resource that is displayed on a computing device.

Computing device 306 receives a request for a shared resource 318 that is indicated as being available. As discussed above, the request for the resource may include a user clicking on a graphical icon that has been provided on the computing device to indicate that the shared resource is available because the computing device/user has access rights to that resource. To re-iterate, a computing device has access rights when the user of the computing device has access rights.

After receiving a request for the resource, computing device 306 communicates the request 322 to the sharing device 302 by way of network 304. As discussed above, the communication between the sharing device 302 and the computing device 306, in exemplary embodiments, is securely communicated. After receiving the request 322, the sharing device 302 determines the access rights 324 for the requested resource. The access rights may be determined by comparing the identity of the requesting user or computing device to the permissions and rights identified in the ACL of the sharing device 302. Once the access rights have been determined to allow access to the requested resource, sharing device 302 shares 326 the resource 328 with computing device 306, by way of the network 304.

Turning now to FIG. 4, a flow diagram is illustrated to show an embodiment of a method 400 for displaying shared resources to which one or more computing devices of a network have access. The method 400 includes block 402, which demonstrates identifying the shared resources of a sharing device. As previously discussed, the resources of a sharing device that are shared by one or more users of the sharing device may be indicated in an ACL. Therefore, identifying the shared resources 402 includes receiving an indication of what resources are shared by a user and referencing a registry such as an ACL. Once the shared resources are identified, block 404 represents creating a message that includes an indication of the shared resources and the related access rights to those resources. The message will convey to other computing devices the resources that are shared, and to which identities those resources are shared. As previously discussed, the message may also include additional information that provides a richer disclosure concerning the shared resource.

Block 406 represents communicating the message to one or more computing devices. In an exemplary embodiment, the communication of the message includes publishing the message to the network for interested computing devices to access. In an alternative exemplary embodiment, the message is broadcast to computing devices of a common network; such that once the receiving computing devices receive the message, the computing devices then decide what additional actions should be taken with regard to the message. Block 408 represents the interpretation of the message by a computing device. As discussed hereinabove, the interpretation of the message may include parsing the message to identify only those resources that the computing device has been granted access rights. Once the resources that provide access rights to the computing device have been identified, the computing device displays those resource to which there are access rights, as described at block 410.

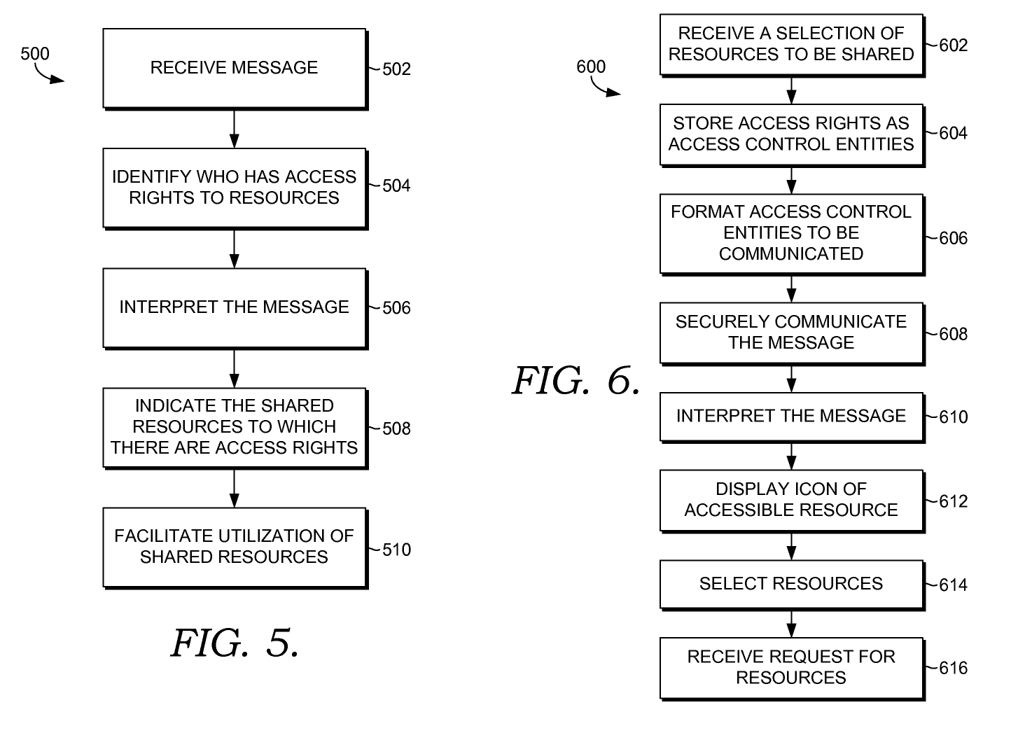

Turning now to FIG. 5, another exemplary embodiment of the present invention is illustrated as a flow diagram to show a method 500 of displaying shared resources to which one or more computing devices of a network have access. The method 500 includes block 502 that represents receiving a message from a sharing device. The message includes a listing of the shared resources of the sharing device. The message identifies which identities (i.e. users and/or computing device) have access to the resources included in the message, as represented at block 504. For example, upon receiving the message, the computing device interprets which of the resources that the computing device has access rights, as represented at block 506. The interpretation of the message allows the computing device to provide an indication of the shared resources to which the computing device has access rights, as represented at block 508. Once the computing device has provided an indication of those resources to which it has access rights, the computing device facilitates utilization of the shared resource, as represented at block 510. The facilitating utilization of the shared resource, in an exemplary embodiment, includes providing a graphical icon that allows a user of the computing device to select the icon that directs the request to the shared resource. In additional embodiments, facilitating utilization of the shared resources opens a communication channel through which the resource and the computing device communicate. The facilitating utilization of the shared resource allows the shared resource to be utilized by way of the computing device.

Turning now to FIG. 6, another exemplary embodiment of the present invention is illustrated as a flow diagram to show a method 600 for displaying shared resources to which one or more computing devices of a network have access. The method 600 includes block 602 that represents receiving a selection of resources to be shared. Receiving of a selection of resources to be shared includes receiving user input of those resources the user wishes to share. Block 604 represents storing the access right as access control entries (ACE) in an ACL. In an exemplary embodiment, each ACE represents one shared resource and an associated access right. In an alternative embodiment, an ACE represents one shared resource and all of the associated access rights.

Block 606 represents formatting the ACE for communication. Formatting the access control entities includes, but is not limited to, creating a message that includes the ACE in a format that is readable by one or more computing devices. In alternative embodiments, formatting an ACE includes truncating information of the ACE to allow efficient communication of that information to one or more computing devices. Block 608 represents securely communicating the message from a sharing device to one or more computing devices. As previously, discussed, secure communication is obtainable in a variety of methods, such as public key encryption, private key encryption, and digital signatures. The secure communication of the message from the sharing device to the one or more computing devices is optional and in an exemplary embodiment, the message is not securely communicated. The determination as to whether the message is securely communicated may depend on predefined rules, conditions, or user selection.

Block 610 represents a receiving computing device interpreting the message. The interpretation of the message may include parsing the message to identify those shared resources that the receiving computing device has access. Once the computing device has interpreted the message, the computing device displays an icon for the accessible resource, as represented at block 612. Block 614 represents a user of the computing device selecting the shared resource by way of the icon, such that the user wishes to access the selected resource. Block 616 represents the sharing device receiving a request for the selected resource from the computing device.

Referring now to FIG. 7, an exemplary illustration of a suitable user interface 700 is shown displaying an indication of those resources to which the displaying computing device has access rights. User interface 700 provides a file system explorer window that graphically indicates those resources available to the current user of the displaying computing device. For example, the current user of the displaying computing device is represented as USER1 702. User interface 700 not only displays those resources of the computing device, but also the resources of other users that the current user has access rights. The shared resources are visually depicted under shared user indication 704 in the file system explorer window. Here, only those resources to which the current user has access are displayed. It is advantageous to display only those resources to which the current user has access instead of displaying all shared resources regardless if there are access rights for the current user as it provides for an efficient working environment. The working environment is more efficient as a result of the current user not having to attempt to find and access a resource to which the user does not have access rights. Instead, user interface 700 only displays those shared resources to which the current user has sufficient access rights to access.

As visually depicted in connection with the shared user 704 resources, one of the shared resources is “PAT” 706. PAT 706 is displayed in the user interface 700 as a result of the inclusion of PAT within a message sent by PAT, and received by the displaying computing device. The message sent by PAT included information indicating that USER1 has access rights to PAT. The displaying computing device interpreted the message and therefore, determined that an indication 706 should be included in the user interface 700 to indicate USER1 has access rights to PAT. As part of the message, additional information is included such as an alias 708 for PAT. The alias 708, describes PAT as WORK_LAPTOP. In an alternative embodiment, the alias is created by USER1 and not determined from the message.

What is claimed is:

1. One or more computer-storage media having computer-executable instructions embodied thereon for performing a method of displaying shared resources to which one or more computing devices of a network have access, the method comprising:
identifying the shared resources of a sharing device that are shared with the one or more computing devices when access rights have been granted to the one or more computing devices;
creating a message indicating, at least, which of the one or more computing devices have access rights to the resources; and
communicating said message to the one or more computing devices, wherein at least one member of the one or more computing devices can interpret the message to identify the resources of the sharing device that are available to the member, so the member can display only those resources included in the message to which the member has access rights.

2. The media of claim 1, wherein the message is pushed to the one or more computing devices.

3. The media of claim 1, wherein the message is a Window Services Discovery message.

4. The media of claim 1, wherein the message additionally includes location information of the resource, such that the resource are accessed utilizing the location information.

5. The media of claim 1, wherein the message is securely communicated to the one or more computing devices.

6. The media of claim 5, wherein securely communicating utilizes public key encryption.

7. The media of claim 5, wherein securely communicating utilizes a digital signature.

8. The media of claim 1, wherein the indication of the access rights in the message includes indications of access rights granted by all users of the sharing device.

9. The media of claim 1, wherein the message additionally includes one of the following:
(1) icon information,
(2) language information,
(3) owner identification,
(4) item name, and
(5) item type.

10. A method of displaying shared resources of a sharing device to which a computing device of a network has access, the method comprising:
receiving a message from the sharing device including a listing of the shared resources of the sharing device, and identifying the computing device as having access rights to at least one of the shared resources;
interpreting the message to determine which of the shared resources the computing device has access rights;
displaying on the computing device an indication of the shared resources to which the computing device has access rights; and
facilitating utilization of the shared resources to which the computing device has access rights by way of the indication.

11. The method of claim 10, wherein the computing device is identified as having access rights to the shared resources by way of the computing device's association with a user, such that the computing device only has access rights to those resources that a current user of the computing device has access rights.

12. The method of claim 10, wherein the resources include:
(1) data,
(2) files,
(3) directories,
(4) printers,
(5) drives,
(6) input device, and
(7) output device.

13. The method of claim 10, wherein the listing of shared resources is derived from an Access Control List (ACL) of the sharing device.

14. The method of claim 10, wherein the message additionally includes location information of the resources on the sharing device, such that the resource are accessed utilizing the location information.

15. The method of claim 10, wherein the listing of resources included in the message is a listing of resources shared by all users of the sharing device.

16. The method of claim 10, wherein interpreting includes parsing the message to identify those resources of the sharing device that a current user of the computing device has been granted access rights.

17. The method of 10, wherein the indication is a graphically displayed icon representing a resource to which the computing device has access rights.

18. The method of 17, wherein the graphically displayed icon is display in a graphical directory of the computing device.

19. The method of claim 18, wherein the graphically displayed icon is used to facilitate utilization of the shared resources by way of providing a link on the computing device that accesses the shared resources of the sharing device upon selection of the graphically displayed icon.

20. One or more computer-storage media having computer-executable instructions embodied thereon for performing a method of displaying shared resources to which a member of one or more computing devices of a network has access, the method comprising:
receiving a selection of the sharing-device resources that are shared with a user of the member, such that access rights to the resources are stored in association with the user to which they are shared, wherein the access rights are stored in the form of Access Control Entries (ACE);
formatting the ACE to be communicated by way of a Window Service Discovery (WSD) message to the one or more computing devices, such that the WSD message will be securely communicated utilizing public key encryption;
securely communicating the WSD message to the one or more computing devices, wherein the member interprets the WSD message to determine if at least one of the ACE is applicable to the member, upon determining at least one of the ACE is applicable, the member displays an icon linking the resource sharing device associated with the member; and
upon selection of the resources by way of the icon displayed on the member, receiving a request to utilize the resources by the member, wherein the WSD message provides information on the location of the resources to facilitate utilization of the resources by the member.
